(19) United States
(12) Patent Application Publication
(10) Pub. No.: US 2009/0168176 A1
(43) Pub. Date: Jul. 2, 2009

(54) Reflective Polymeric Article and Manufacture

(76) Inventors: Ravi Sriraman, Pune (IN); Chinniah Thiagarajan, Bangalore (IN); Ajay Taraiya, Bangalore (IN)

Correspondence Address: SABIC - 08CS - STRUCTURED PRODUCTS;SABIC Innovative Plastics - IP Legal, ONE PLASTICS AVENUE, PITTSFIELD, MA, 01201-3697, US

(21) Appl. No.: 11/965,938

(22) Filed: Dec. 28, 2007

(51) Int. Cl. G02B 5/124; B29D 11/00

(52) U.S. Cl. 359/515; 264/1.1

(57) ABSTRACT

A method of making a reflective polymer article comprising: (a) contacting a polymer material with a foaming agent; (b) foaming in the material under conditions sufficient to form reflective polymer article having gas cells and polymer gas interfaces between the cells; wherein the reflective polymer article has a metallic or reflective property.

### BACKGROUND

This invention is related to foamed polymeric articles. More particularly this invention is related to foamed polymeric articles containing multiple layers of polymer gas interfaces.

Generally, plastic films are dyed or pigmented to provide the desired color or optical characteristics. To make mirror like reflective surface, the plastic films are conventionally metallized by several known techniques such as vacuum deposition method. However, the material and process involved are both expensive and time consuming.

Stacked layers of material in the order of the wavelengths of visible light (about 500 nm) are known to show high reflective properties due to light wave interference and the difference in refractive index between the layers, the air, and the material.

Highly reflective colored plastic film are known, which may be prepared by the coextrusion technique from a transparent plastics having no pigment or inorganic material. The process shows forming a film from a number of layers of different thermoplastic materials, which differ in refractive index and the layer thicknesses from about 0.05 micron to about one micron.

The fabrication process to produce a uniform stack of very thin polymeric films requires good control on thickness of the layers, which is difficult. In addition, the extrusion process requires special machines to handle the sub-micron thick films and addition of pigments or reflective fillers e.g. mica platelet could cause undesirable flow line defects.

Thus there is a need for articles with good reflective characteristics at relatively low cost. There is a need for an improved, and cost effective process to prepare thermoplastic article having a metallic appearance.

### BRIEF DESCRIPTION

In one aspect, the present invention provides a method of making a reflective polymer article comprising: (a) contacting a polymer material with a foaming agent; (b) foaming in the material under conditions sufficient to form reflective polymer article having gas cells and polymer gas interfaces between the cells; wherein the reflective polymer article has a metallic or reflective property.

In another aspect, the present invention relates to an article comprising: a polymer material having gas cells and polymer gas interfaces between the cells; wherein the reflective polymer article has a metallic or reflective property.

Various other features, aspects, and advantages of the present invention will become more apparent with reference to the following description, examples, and appended claims.

### DETAILED DESCRIPTION

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

The term “polycarbonate” refers to polycarbonates incorporating structural units derived from one or more dihydroxy aromatic compounds and includes copolycarbonates and polyester carbonates.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

Polymer material may be any polymeric material for making polymer foam and articles therefrom. In various embodiments, the polymer contains a thermoplastic polymer, an amorphous polymer, a semi-crystalline polymer, a thermoset polymer, or mixtures of two or more of the foregoing types of polymers.

Thermoplastic polymers that may be used are oligomers, polymers, ionomers, dendrimers, copolymers such as block copolymers, graft copolymers, star block copolymers, random copolymers, or the like, or combinations comprising at least one of the foregoing polymers. Suitable examples of thermoplastic polymers include polyacetals, polyacrylics, polycarbonates polystyrenes, polyesters, polyamides, polyamideimides, polyarylates, polyarylsulfones, polyethersulfones, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfonamides, polyureas, polyphosphazenes, polysilazanes, or the like, or combinations comprising at least one of the foregoing thermoplastic polymers. In an embodiment, the thermoplastic polymer comprises an acrylic resin, a polycarbonate, a polyolefin, a polyester, or a polyvinyl chloride. In another embodiment, the thermoplastic polymer comprises a polyetherimide or a polycarbonate. Polyetherimides and polycarbonates can be prepared by methods known in the art. Polycarbonates are particularly useful since they have high toughness, excellent transparency, and good moldability. In a particular embodiment, polycarbonates prepared from bisphenol A, either as a monomer or a comonomer are useful polymers for producing foams and foamed articles due to their good optical transparency, good mechanical properties, good impact properties. Thus, a polycarbonate foamed article having tough impact strength, super-insulation, and optical transparency can be produced using the techniques described herein. The polycarbonate resin for use is generally obtained from a dihydric phenol and a carbonate precursor by an interfacial polycondensation method or a melt polymerization method. Typical examples of the dihydric phenol include those disclosed in U.S. Patent Application Publication No. 2003/0207082 A1. In another embodiment, polycarbonates produced from 2,2-bis(4-hydroxyphenyl)alkanes and/or bisphenol A may be employed for producing the foams and foamed articles disclosed herein.

Non-limiting examples of semi-crystalline thermoplastic polymers include polybutylene terephthalate, polyphenylene sulfides, polyetheretherketones (PEEK), polyetherketones (PEK), polyphthalamides (PPA), polyetherketoneketones (PEKK), and high temperature nylons. Blends of thermoplastic polymers may also be used. Examples of blends of thermoplastic polymers include those materials disclosed in U.S. Patent Application Publication No. 2005/0112331 A1. In one embodiment, of the present invention, the thermoplastic polymers used herein may also contain thermosetting polymers. Examples of thermosetting polymers are polyurethanes, natural rubber, synthetic rubber, epoxy, phenolic, polyesters, polyamides, polyimides, silicones, and the like, and mixtures comprising any one of the foregoing thermosetting polymers. In one embodiment, the polymer substrate may be a sheet or film. In another embodiment, the polymer substrate may be oriented in one direction. In yet another embodiment, the polymer substrate may be oriented in different directions.

As disclosed herein, the term “foaming agent” also referred as “blowing agent” may be a chemical blowing agent or physical blowing agent. The foaming agent may be a solid, a liquid, or a supercritical material. Blowing or foaming agents that may be used include inorganic agents, organic agents and other chemical agents. Suitable inorganic blowing agents include but are not limited to carbon dioxide, nitrogen, argon, water, air, and inert gases such as helium and argon. Organic agents include but are not limited to aliphatic hydrocarbons having 1-9 carbon atoms, aliphatic alcohols having 1-3 carbon atoms, and fully and partially halogenated aliphatic hydrocarbons having 1-4 carbon atoms. Non-limiting examples of aliphatic hydrocarbons include methane, ethane, propane, n-butane, isobutane, n-pentane, isopentane, neopentane, and the like. Non-limiting examples of aliphatic alcohols include methanol, ethanol, n-propanol, and isopropanol. Fully and partially halogenated aliphatic hydrocarbons include fluorocarbons, chlorocarbons, and chlorofluorocarbons. Examples of fluorocarbons include methyl fluoride, perfluoromethane, ethyl fluoride, 1,1-difluoroethane (HFC-152a), 1,1,1-trifluoroethane (HFC-143a), 1,1,1,2-tetrafluoro-ethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane, and the like. Partially halogenated chlorocarbons and chlorofluorocarbons include methyl chloride, methylene chloride, ethyl chloride, 1,1,1-trichloroethane, 1,1-dichloro-1-fluoroethane (HCFC-141b), 1-chloro-1,1-difluoroethane (HCFC-142b), chlorodifluoromethane (HCFC-22), 1,1-dichloro-2,2,2-trifluoroethane (HCFC-123), 1-chloro-1,2,2,2-tetrafluoroethane (HCFC-124), and the like. Fully halogenated chlorofluorocarbons include trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. Other chemical agents include azodicarbonamide, azodiisobutyronitrile, benzenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, trihydrazino triazine, and the like.

In one embodiment, the foaming agent may be selected from the group consisting of carbon dioxide, air, nitrogen, argon, gaseous hydrocarbons, and combinations thereof. The foaming agent may be selected from the group consisting of solid carbon dioxide, liquid carbon dioxide, gaseous carbon dioxide, or supercritical carbon dioxide. Any of the inert gases, such as for example, helium, xenon, and argon may be used. Non-limiting examples of gaseous hydrocarbons include methane, ethane, propane, and butane. In another embodiment, halohydrocarbons that may be expected to be in a gaseous form at ambient temperature and pressure may be used. Non-limiting examples of such halohydrocarbons include fluorohydrocarbons, fluorocarbons, chlorocarbons, and chlorofluorocarbons. In one embodiment, the gas cells may be a gas bubble formation in the foam substrate, which may be generated during foaming process in the presence of a physical or a chemical foaming agent.

In one embodiment the pores of gas cells may be of any shape for example spherical, circulars, acircular, aspherical, elliptical, cylindrical, plates, flakes, and may have a regular or irregular shape. In another embodiment, the aspect ratio (the thickness to lateral dimension ratio) of the pore is greater than 1. The foamed polymer may have an average pore size at or above about 10 nanometers, and up to about 500 nanometers. In other embodiments, the foams may have an average pore size from about 10 nanometers to about 200 nanometers, and from about 10 nanometers to about 100 nanometers. In other embodiments, the foams may have an average pore size from about 100 nanometers to about 2000 nanometers, and from about 100 nanometers to about 1000 nanometers

In one embodiment, one or more techniques may be used to increase in the number of voids in the foamed polymer substrate per unit volume (also defined herein as ‘cell density’) for example to about a billion voids per cubic centimeter in the foamed polymer substrate. In one embodiment, a combination of physical blowing agent, a surface tension modifier, application of a pulsating pressure, and a temperature quench step may be used to create voids and establish cell density. In another embodiment, the extruder screw and the die may be designed in such a way so as to maximize the pressure drop in the extruder. In another embodiment, the increase in the cell density may be achieved by various other techniques known in the art. For example, polymer material may be saturated with a high concentration of the foaming agent, such as carbon dioxide, at a low temperature, such as below ambient temperature.

The polymer material for processing into cellular foams may also include one or more fire-retardant agents admixed therewith. Any of fire-retardants may be used, such as those known in the art. Other materials or additives, such as antioxidants, anti-drip agents, anti-ozonants, thermal stabilizers, anti-corrosion additives, impact modifiers, ultra violet (UV) absorbers, mold release agents, fillers, anti-static agents, flow promoters, impact modifiers, pigments, dyes, and the like, such as, for example, disclosed in U.S. Patent Application Publication No. 2005/0112331 A1, can be provided. In one embodiment, fillers that may help in the foaming process and/or help improve the properties, such as for example, dielectric properties, mechanical properties, and the like may be added.

Dyes or pigments may be used to color the article. Dyes are typically organic materials that are soluble in the resin matrix while pigments can be organic complexes or even inorganic compounds or complexes, which are typically insoluble in the resin matrix. These organic dyes and pigments include the following classes and examples: furnace carbon black, titanium oxide, zinc sulfide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

Colorants such as pigments and/or dye additives may also be present. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. Pigments are generally used in amounts of about 0.1 to about 20 parts by weight, based on 100 parts by weight of the polymer portion of the composition.

In one embodiment polymer material, and foaming agent may be contacted in an extruder. Additive may also be fed into the extruder along with the polymer material and foaming agent. In one embodiment, the components may be contacted in a masterbatch. The polymer material, foaming agent and any additives together may also be referred to as feed material. In one embodiment, feed material may be produced by melt blending. The melt blending may be carried out in a single step using any effective device, such as single and twin-screw extruders, Buss kneaders, roll mills, Waring blenders, Henschel mixers, helicones, Banbury mixers, or the like, or combinations of the at least one of the foregoing melt blending devices.

In one embodiment, the polymer material, foaming agent and any additives may be contacted at a temperature in a range from about −100° C. to about 400° C. to form a polymer material concentrated with foaming agent comprising gas cells. In another embodiment, the contacting may be performed at a temperature in a range from about 0° C. to about 250° C. In yet another embodiment, the contacting may be performed at ambient temperature. In an embodiment, the contacting may be carried out at a temperature from about −100° C. to about 20° C. In another embodiment, the contacting may be carried out at a temperature from about −40° C. to about ambient temperature, and in still another embodiment, the contacting may be carried out at a temperature from about −40° C. to about 20° C. Higher temperatures, such as for example, the melting temperature of the polymer may also be used. In another embodiment, the contacting may be carried out at a temperature from about −40° C. to about melt temperature of the polymer substrate. In one embodiment, the contacting may be carried out at a pressure from 0.1 N/mm² to about 1000 N/mm². In another embodiment, the contacting may be carried out at a pressure from 1 N/mm² to about 750 N/mm². In yet another embodiment, the contacting may be carried out at a pressure from 50 N/mm² to about 600 N/mm².

In one embodiment, foaming of saturated polymer material may be carried out by solid-state foaming, by chemical decomposition, or by phase separation process. For example, in solid-state foaming, the foaming agent gas molecules may diffuse into the polymer at a very high saturation pressures to form a single phase (also sometimes referred to as the “homogeneous phase”) of “gas-polymer” portion of the polymer material. While doing so, a pressure quench may appear in the gas-polymer phase, which may lead to instability in the system and gas molecules may separate themselves from the polymer, which may result in nucleation and growth of gas bubbles.

In one embodiment, the polymer foams may be developed by (i) stretching the polymer sheet under uni-axial tension to form oriented multiple polymer layers; (ii) contacting the polymer sheet with the foaming agent at room temperature or elevated temperature under high pressure adjusting a total time taken for forming the polymer and gas in “homogeneous phase”; and (iii) putting the homogeneous polymer and gas material at temperature close to the Tg of the polymer material under compressive load followed by pressure and temperature quenching. In one embodiment, the quenching of the reflective polymer article may be carried out at a temperature from about 0° C. about ambient temperature and a pressure from about 0.1 N/mm² to about 1000 N/mm². In another embodiment, the quenching of the reflective polymer article may be carried out at a temperature from about 0° C. about 22° C. and a pressure from about 0.1 N/mm² to about 1000 N/mm². In one embodiment, the foaming may further include a step of applying a force to create a plurality of gas cells. In another embodiment, the gas cells may have a platelet structure having a planar interface. In one embodiment, the foaming may restrict the growth of the foam in one direction. In another embodiment, the foaming may restrict the growth of the foam in more than one direction. In one embodiment, restriction of foam growth in one direction may be in the direction of the thickness of the article. In another embodiment, the restriction of foam growth may be in a range from about 1% to about 10%.

In one embodiment, stretching may create multilayered material with at least two layers. Stretching may be achieved by pulling the polymer sheet under uni-axial, bi-axial, or multi-axial ways. In another embodiment stretching orientation may create platelets or lamellar structure in the oriented material.

In one embodiment, stretched CO₂ saturated polymer material may be subjected to depressurization. In another embodiment, the depressurized polymer material may be heated to a temperature near the glass transition temperature (Tg) of the polymer material. The heating may also be carried out under compressive load. On heating the polymer material under a compressive load, the CO₂ in the polymer material may grow in-between the polymer material layers and separates them leaving a void between the layers to give a foamed polymer material. In one embodiment, the growth of the CO₂ in the polymer material may be two dimensional. In another embodiment, there may be a difference in the refractive index of the polymer material layer and the void that may be present in the foamed polymer material.

In one embodiment, the method of making a reflective polymer article described above may be implemented in a batch, semi-batch, or a continuous process. In one embodiment, the polymer material and the additives may also be coextruded. In another embodiment, the method of making a reflective polymer article is a continuous process. In another embodiment, the process may allow production of polymer foams having a relatively uniform and a narrow pore size distribution having an average pore size of less than or equal to about one time the standard deviation. In yet another embodiment, the process may be carried out using an extruder and injection molding machines

For example, the reflective polymer substrate may be prepared using a sheet extruder at a temperature of about 145° C. The extrusion may then be followed by biaxial stretching under a strain of about 100% to form a stretched polymer substrate. The stretched polymer substrate may then be saturated with carbon dioxide at a temperature of about 22° C. A shaping die or calibrator may be employed during the foaming stage for anisotropic foaming that may result in formation of the reflective polymer substrate.

In one embodiment, the reflective polymer article may contain a plurality of layers having gas cells with polymer/gas/polymer interfaces. For example, if the polymer material is represented as A and the gas cell is represented as B, the layers are arranged alternately like ABABABAB. In another embodiment, the reflective polymer article may be independent of the layer arrangement and other sequences of layer arrangement.

In one embodiment, adjacent layers of gas cells and polymer material differ from each other in refractive index by at least about 0.05. In another embodiment the adjacent layers of gas cells and polymer material differ from each other in refractive index in a range from about 0.05 to 5 or from about 0.5 to about 1. In one embodiment, the reflective polymer article having a metallic color may be obtained by stretching a plastic material with a layered structure.

In one embodiment, the reflective polymer article may reflect at least about 60 percent of the electromagnetic spectrum incident on the surface of the article. The term “electromagnetic spectrum” may be defined as the full frequency range of electromagnetic radiation, and contains radio waves, microwaves, infrared, ultra violet, visible, and x-rays. In another embodiment the reflective polymer article may reflect in a range from about 60 percent to about 90 percent of the electromagnetic spectrum incident on the surface. In one embodiment, the reflective polymer article reflects at least 70 percent of light at a wavelength within the visible and infrared range. In another embodiment, the reflective polymer article reflects at least 70 percent of light at a wavelength in the infrared range, or reflects at least 70 percent of light at a wavelength in the visible range. In one embodiment, the reflective polymer article may reflect at least about 60 percent of the electromagnetic spectrum incident on the surface of the article due to the presence of a plurality of layers having gas cells with polymer/gas/polymer interfaces that may differ from each other in refractive index by at least about 0.05.

In one embodiment, the reflective polymer article may reflect the electromagnetic spectrum so as to provide a metallic appearance for example a silvery appearance. A metallic appearance may be defined by greater than about 60% of reflected light, which may reach the observer. Also, the reflected light may show angle dependent changes in the reflection, which may produce a color shift appearance. A silver metallic appearance may be defined as a color, which may show greater than about 60% of reflected light across the visible spectrum, from 380 to 780 nm. In another embodiment, the reflective polymer article may be of multiple layers providing an article having varied colors or hues. In general, if the reflected spectrum shows a relatively higher reflection of greater than about 60% in a particular wavelength range, then this may be displayed as a color of that wavelength. For example, a peak reflection around 400 nm shows a blue color. Similarly a peak reflection around 550 nm shows a green color.

The reflective polymer article may be used for producing a variety of applications. In one embodiment, the article may be a flowline free extruded article with metallic effect. In another embodiment, the article may be injection molded article with metallic effect. In one embodiment, the reflective polymer article may be used for producing sheets or panels, some examples of which include an integrated sandwich panel, a co-laminated panel, a co-extruded panel comprising an inner sheet, graded sheets, co-extruded sheets, corrugated sheets, multi-wall sheets, an integral sheet structure comprising a sheet of reflective polymer article and a reinforced skin as a top layer, and a multi-wall sheet structure comprising at least one reflective polymer article sheet disposed between two or more plastic sheets. The reflective polymer article may also comprise an energy absorbing material, a packaging material, a thermal insulation material, an acoustic insulation material, a building construction material, or a building glazing material. Some specific application areas for super-insulating foam include for example, buildings, refrigerators and refrigeration systems, heaters and heating systems, ventilation systems, air conditioners, ducting systems for transporting hot or cold materials, such as for example liquids, air, and other gases; and cold rooms. Super-insulation foamed structures containing the reflective polymer substrate may also be used for making high temperature turbine parts, such as for example, turbine blades. Super-structural and super-insulation foamed structures containing the reflective polymer article may be used in building and construction panels, including opaque super-insulating sandwich panels. Some examples of applications of the reflective polymer article as a material having both super-structural properties and transparency include roof glazings, building glazings, construction glazings, automotive glazing. In another embodiment, panels or sheets comprising the reflective polymer article may include an airplane or an automobile outer structural component, a roof, a greenhouse roof, a stadium roof, a building roof, a window, a skylight, or a vehicular roof.

In another embodiment, various articles sensitive to ultraviolet radiation are readily protected by over-wrapping in an ultraviolet reflecting film of this invention which is transparent to visible light. Meats (both fresh and processed), nuts, cheese and like comestibles which are altered by exposure to excessive amounts of ultraviolet radiation are protected and yet are readily visible for inspection.

There are many applications where film having strong reflection in the infrared may be useful, for example; in an air-conditioned building or vehicle such as glazing, it may be useful to laminate reflective polymer article to another material, such as conventional window glass, to provide mechanical strength and oftentimes scratch resistance and/or chemical resistance. Infrared reflective polymer article may be incorporated within the plastic layer of conventional safety glass.

Reflective polymeric articles of this invention may have a wide variety of potentially useful applications. For example, articles may be post formed into concave, convex, parabolic, half-silvered, etc. mirrors. The mirror-like appearance may be accomplished by coextruding a black or otherwise light absorbing layer on one side of the body. Alternatively, one side of the final body may be coated with a colored paint or pigment to provide a highly reflective mirror-like body. Such mirrors may not be subject to breakage as would glass mirrors.

The reflective polymer article may also be used in birefringent polarization. Through proper selection of the polymer materials making up the layers, a refractive index differential in one plane of the polarizer may be achieved. In a preferred method, the refractive index differential may be created after fabrication of the reflective polymer article. The polymer materials may be selected so that the first material has a positive stress optical coefficient and the second polymer material has a negative stress optical coefficient. Stretching the material containing the two polymer materials in a uni-axial direction may cause them to orient and may result in a refractive index differential in the plane of orientation to produce a polarizer.

Additionally, the highly reflective polymer article may be fabricated as non-corroding metallic appearing articles for indoor or outdoor exposure. For example, the reflective polymer article may be fabricated into signs, or bright work for appliances. The reflective polymer article may be post formed into highly reflective parts such as automotive head lamp reflectors, bezels, hub caps, radio knobs, automotive trim, or the like, by processes such as thermoforming, vacuum forming, shaping, rolling, or pressure forming. The reflective polymer article may also be formed into silvery or metallic appearing bathroom or kitchen fixtures, which do not corrode or flake.

In one embodiment, the reflective polymer article may be formed by coextruding into different shapes for example films, sheets, channels, lenticular cross-sections, round tubes, elliptical tubes, or parisons s. For example, decorative moldings such as wall moldings and picture frame moldings, automotive trim, home siding, silvery appearing bottles and containers and the like may be readily coextruded through forming dies. The reflective polymer article may also be employed into a wide variety of articles such as two-way mirrors, infrared reflectors for insulation, solar intensifiers to concentrate solar radiation, dinnerware, tableware, containers, microwavable articles, and packages.

In one embodiment the reflective polymer article may be more readily understood, reference is made to the following examples, which are intended to be illustrative of the invention, but are not intended to be limiting in scope.

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. The following examples are intended only to illustrate methods and embodiments in accordance with the invention, and as such should not be construed as imposing limitations upon the claims.

### Example 1

A sheet of polycarbonate (LEXANΘ resin from SABIC Innovative Plastics) (10×50×3 mm) was provided and treated with carbon dioxide gas at around 25° C. and a pressure of about 60 bar for a period of about five days in a pressure vessel. The concentration of carbon dioxide in the polycarbonate was measured to increase to about 10.5 percent after removing from the pressure vessel (with an operating pressure range of about 100 bar, diameter of about 60 mm and a depth of about 120 mm, with provision for gas inlet and outlet with a pressure indicator and temperature sensor) by using a weighing balance. On a set of 6 samples, 3 were used for weight gain measurement and 3 for foaming experiments, respectively. The treated polycarbonate sheet was then depressurized by releasing the pressure release valve. The sample was removed from the pressure vessel and subjected to a temperature of about 140° C., by immersing in hot liquid container for about 15 minutes. The sheet was clamped to a fixture throughout the foaming process. The increase in thickness of the sample during foaming process was used to constrain the foam during this process. A 3 mm thick solid sheet increased in thickness to about 6 mm during foaming process to obtain a foamed sample. In constrained foaming the thickness increased was constrained to about less than 4 mm. The foamed sheet with fixture was immersed in a water bath for about 5 minutes to cool and stabilised the foamed sample.

### Example 2

Example 2 was prepared using the procedure in Example 1 with polyetherimide (ULTEMΘ resin from SABIC Innovative Plastics) instead of polycarbonate and a temperature at which the treated sheet of polyetherimide was heated at about 225° C.

### Example 3

Red colored Lexan sheets was prepared using the procedure in Example 1 with the addition of Lumogen F Red 305 (Manufacturer BASF). Based on the ASTM D-1003-00 90% of the incident light was reflected in the visible region as measured using a spectrophotometer.

### Example 4

Polycarbonate sheet was uniaxially drawn through a tapered die and tensile bars were drawn using Instron Tensile Testing machine at about 145° C. with draw ratio of around 2. The polycarbonate sheet then underwent the foaming process as described above for Example 1. The reflectivity of the article was measured using ASTM D-1003-00 indicating 80% of the incident light was reflected in the visible region.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A method of making a reflective polymer article comprising:
a. contacting a polymer material, wherein the polymer material is oriented in at least one direction, with a foaming agent; and
b. foaming the material under conditions sufficient to form a reflective polymer article having gas cells and polymer gas interfaces between the cells;
wherein the reflective polymer article has a metallic or reflective property.

2. The method of claim 1, wherein the foaming comprises applying a force to create a plurality of gas cells with a platelet structure having a planar interface.

3. The article of claim 1, wherein the article comprises one or more thermoplastic polymer, amorphous polymer, thermoset polymer, or semi-crystalline polymer.

4. The method of claim 3, wherein the polymer comprises thermoplastic polymer of a polyetherimide or polycarbonate.

5. The method of claim 1, wherein the article is sheet or film.

6. (canceled)

7. The method of claim 1, wherein the foaming agent is chemical or physical blowing agents.

8. The method of claim 1, wherein the foaming agent is solid, liquid, gaseous, or supercritical material.

9. The method of claim 1, wherein the foaming agent is selected from the group consisting of carbon dioxide, air, nitrogen, argon, gaseous hydrocarbons, and combinations thereof.

10. The method of claim 9, wherein the foaming agent is solid, liquid, gaseous, or supercritical carbon dioxide.

11. The method of claim 1, further comprising quenching the article.

12. The method of claim 1, wherein the method is a continuous process.

13. (canceled)

14. An article made by the method comprising:
a. contacting a polymer material, wherein the polymer material is oriented in at least one direction, with a foaming agent;
b. foaming the material under conditions sufficient to form a reflective polymer article having gas cells and polymer gas interfaces between the cells;
wherein the reflective polymer article has a metallic or reflective property.

15. An article comprising:
a reflective polymer material having gas cells and polymer gas interfaces between the cells causing the material to reflect the electromagnetic spectrum so as to have a metallic or reflective appearance;
wherein the reflective polymer reflects at least 70 percent of light at a wavelength in the ultraviolet range; and/or
wherein the article reflects at least 70 percent of light at a wavelength within the visible and infrared range.

16. The article of claim 15, wherein the material has a plurality of gas cells with a platelet structure having a planar interface.

17. The article of claim 14, which reflects a significant amount of a range of the electromagnetic spectrum.

18-19. (canceled)

20. The article of claim 15, wherein the reflective polymer reflects at least 60 percent of the electromagnetic spectrum.

21. The method of claim 1, further comprising stretching the polymer material prior to contacting the polymer material with the foaming agent.

22. An article comprising: a reflective polymer material having gas cells and polymer gas interfaces between the cells causing the material to reflect the electromagnetic spectrum so as to have a metallic appearance.
